(19) United States
(12) Patent Application Publication
(10) Pub. No.: US 2005/0263353 A1
(43) Pub. Date: Dec. 1, 2005

(54) Merchandizing display systems and methods

(76) Inventor: Steven Andrew Jennings, Naperville, IL (US)

Correspondence Address: RYNDAK & SURI, 30 NORTH LASALLE STREET, SUITE 2630, CHICAGO, IL, 60602, US

(21) Appl. No.: 10/852,806

(22) Filed: May 25, 2004

(51) Int. Cl. B61B 1/00; B65G 1/00; E04H 3/00; A47F 3/14; A47J 47/00

(52) U.S. Cl. 186/52

(57) ABSTRACT

A merchandising system for displaying food items from selected food groups with the packaging of the food items having a distinct color associated with each food group. Other indicia on the display system are color coordinated with the colors of the packaging such that the different food items and the indicia create a plurality of visually separate and distinct color groups for easier selection of the desired food items. The colored indicia on the display system may include colored edges on shelves or colored badges or medallions, which are located adjacently to, and associated with, the colored packaging for the food items of the respective food groups. The display types may include free-standing, counter, stepped overlay and refrigerated displays.

### FIELD OF THE INVENTION

The present invention relates generally to merchandizing display systems and methods. More particularly, the invention relates to such display systems and methods which utilize color coding to arrange different food items into visually distinct color groups.

### BACKGROUND OF THE INVENTION

The United States Department of Agriculture (USDA) has previously devised a food pyramid as a general guide for choosing a healthful diet. The top tip of the food pyramid includes fats, oils and sweets that should be used sparingly. The second level includes both dairy products, such as milk, yogurt and cheese, and meat, including poultry, fish, dry beans, eggs and nuts. These food products are important sources of protein, calcium, iron and zinc. The third level of the food pyramid includes both vegetables and fruit, which supply vitamins, minerals and fiber. At the base of the food pyramid are breads, cereals, rice and pasta, which provide carbohydrates, vitamins, minerals and fiber.

This food pyramid assists in an understanding of what food choices are desirable for a healthy diet. However, grocery stores do not typically arrange food items in accordance with the USDA food pyramid or otherwise assist the grocery shopper in selecting the appropriate food choices from the food pyramid. There has also been some questioning or criticism of the USDA food pyramid since other factors also are important to a healthy lifestyle. For example, various weight control programs and a regimen of daily exercise are also important considerations for many persons in any program to maintain health and weight control.

Furthermore, children and adolescents are typically less educated in food selection in accordance with the food pyramid, including the desirability to make healthy food choices. Frequently, these age groups tend to select food high in sugars, such as candy, soda pop, cookies or the like, or food high in fat and sodium, such as processed snack foods. Recent reports indicate that increasing numbers of adolescents are over-weight. There are also significant longer-term health risks associated with becoming over-weight at an early age, such as the early onset of diabetes. Assistance in the selection of healthy food products for these younger age groups would be particularly beneficial to their long term prospects for a healthy life.

There has been a long-felt need for approaches or systems that encourage and facilitate the selection of healthy food products.

Accordingly, it is a general object of the present invention to provide a display system with color coordination between elements of the display system and the available food items to assist in the selection of a food item from a desired food group.

Another general object of the present invention is to provide methods of displaying, selecting and selling food items arranged in food groups, with the food groups being color coordinated with correspondingly colored indicia on the display system for ease of identification and selection of a food item from the desired food group.

Yet another object of the present invention is to represent each of the available food groups and food items in the display system with a distinctive color and to group or segregate the different food groups into visually separate and distinctive color groups.

A further object of the present invention is to provide color coordinated display systems in a variety of different configurations such that at least one configuration is suitable for most point of sale environments.

A still further object of the present invention is to provide packaging for the food items that has substantially the upper portion of the packaging of the same color as the associated food group such that the food items, when arranged in the display system, provide visually separate and distinctive color groups.

### BRIEF SUMMARY OF THE INVENTION

This invention is directed to a merchandising display system for basic food groups such as protein, whole grains, fruits and vegetables. Each of these food groups is represented by a distinctive color. For example, the color red may be used for protein, yellow for whole grains, purple for fruit and green for vegetables. If desired, certain of the food groups may be combined; for example, vegetables and fruit. The food may be in solid form, liquid form, semi-solid form or semi-liquid form. The packaging for the food is color-coordinated with corresponding colored indicia on the merchandizing display. For example, the tops and labels of bottles, such as for beverages, will be predominantly the same color as the indicia on the merchandizing display for that particular food group. Similarly, at least the top or upper portion of the packaging for solid foods will be substantially the same color as the corresponding colored indicia on the merchandizing display, with the exception of other colors that may be used for the brand or logo, the descriptive identification of the food product, any pictorial representation of the food item, the ingredients in the food product, and so forth.

The colored indicia on the display may consist of colored edges on shelves, separately colored badges or medallions, or the like. Such colored indicia on the display are located adjacently to, and associated with, the same colored items for the respective food group. The display thus segregates the different food groups and the colored indicia on the display into visually separate and distinct color groups for easier selection of a food item from the desired food group by the consumer, including by those of younger ages.

The displays may take a variety of different forms including free-standing floor displays, counter displays, refrigerated cooler displays, shelf rack displays for horizontally disposed grocery shelves, ramped or stepped overlay displays for horizontally disposed coolers or refrigerated units, and the like. In each of the different forms of the display, the food items are grouped, separated or segregated into the different colors representing the different food groups for convenient product selection by the consumer.

This invention also relates to methods of displaying, selecting and selling food products from at least some of the different food groups through the use of such color-coordinated displays and color-coordinated packaging for the food items that separate or segregate the different available food groups into visually distinct color groups.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 is a front perspective view of a free-standing display system for displaying food items from different food groups with the packaging of the food items color coordinated with similarly colored indicia on display system and with the food items grouped or segregated into distinctive color groups representative of available food groups in accordance with the present invention;

FIG. 2 is a front perspective view of a free-standing display system similar to the display system in FIG. 1 with three food groups instead of the four food groups shown in FIG. 1 and which also utilizes the aforementioned color grouping and segregation techniques;

FIG. 3 is a perspective view of a four-sided counter display system with the packaging of the food items color coordinated with similarly colored badges or medallions on the display system that identify the available food groups with each of the food groups having a separate shelf;

FIG. 4 is a perspective view of a single-sided display system with the food items for each food group arranged in respective rows with similarly colored badges or medallions on the display system associated with the food items of the respective food group;

FIG. 5 is a perspective view of a stepped display system suitable for overlaying on a cooler, with each of the steps used for the food items from one of the available food groups and with each food group prominently identified by badges or medallions that are colored similarly to the packaging of the associated food items for the respective food group;

FIG. 6 is an elevational view of a display system suitable for mounting to a vertical surface, such as to a cooler or wall, the display system having food items arranged vertically with each food group prominently identified by an enlarged color patch that is colored similarly to the packaging of the associated food items for the respective food group;

FIG. 7 is a front perspective view of a display system suitable for mounting to the edges of a plurality of horizontally disposed shelves, such as those commonly used in grocery stores, with the food items for each of the available food groups arranged on a separate shelf of the display system and with each food group prominently identified by badges or medallions that are colored similarly to the packaging of the associated food items for the respective food group;

FIG. 8 is a front perspective view of a plurality of separate arcuate shelves, with each of the shelves attached to the edge of a separate horizontally disposed shelf and with each of the separate arcuate shelves suited for displaying the food items associated with one of the available food groups, with each food group prominently identified by a badge or medallion that is colored similarly to the packaging of the associated food items for the respective food group;

FIG. 9 is a front perspective view of a stepped display system suitable for overlaying on a cooler, with each of the steps used for the food items from one of the available food groups and with each food group prominently identified by badges or medallions that are colored similarly to the packaging of the associated food items for the respective food group;

FIG. 10 is a perspective view of a display system in the form of a rack consisting of a plurality of rows suitable for overlaying on a cooler, with each of the rows used for the food items from one of the available food groups and with each food group prominently identified by badges or medallions that are colored similarly to the packaging of the associated food items for the respective food group; and

FIG. 11 is a perspective view of a display system in the form of a rack consisting of a plurality of rows suitable for overlaying on a cooler, similar to the display system of FIG. 10, but with fewer rows and fewer available food groups, with each of the rows used for the food items from one of the available food groups and with each food group prominently identified by badges or medallions that are colored similarly to the packaging of the associated food items for the respective food group.

### DESCRIPTION OF THE PREFERRED EMBODIMENTS

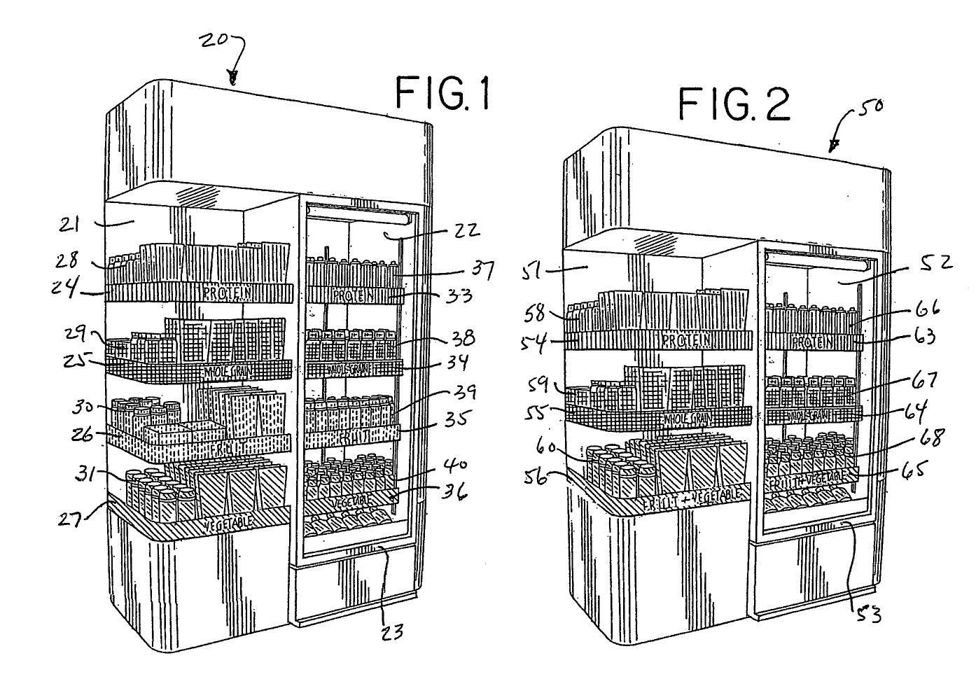

A merchandising display system, generally designated 20, constructed in accordance with the present invention is shown in FIG. 1. Display system 20 includes a refrigerated portion 22 and an open or room temperature portion 21. A door 23 provides access to the refrigerated portion. Typically, the refrigerated portion 22 will be used to keep liquid foods, such as beverages, chilled. However, where desirable, solid foods may also be chilled in the refrigerated portion 22 of the display system. Display system 20 could, of course, be modified into a vending machine format or style if so desired. It may be a stand-alone display system, form part of an aisle such as in a grocery store or be an end cap of an aisle in a grocery store.

In the exemplary display system 20 of FIG. 1, the room temperature portion 21 is provided with four shelves 24-27 for displaying a plurality of food items 28-31. These food items are preferably selected from nutritional and wholesome food groups such as protein food items 28, whole grain food items 29, fruit food items 30 and vegetable food items 31. Food items 28-31 may be packaged in paperboard, plastic or glass containers, as desired or deemed appropriate for the particular food item.

Similarly, the refrigerated portion 22 of display system 20 is provided with four shelves 33-36 for displaying a plurality of food items 37-40, which may also be selected from nutritional and wholesome food groups, such as protein food items 37, whole grain food items 38, fruit food items 39 and vegetable food items 40. Note that food items from the fat or carbohydrate food groups of the traditional food pyramid, such as the USDA food pyramid, have been de-emphasized or that food items offered may contain reduced amounts of fats or carbohydrates. These refrigerated food items 37-40 may also be in any conventional packaging, such as paperboard, plastic or glass, as desired or deemed appropriate for the particular food item. In the example of FIG. 1, the refrigerated food items 37-40 are packaged mostly in plastic or glass bottles, such as are commonly used for beverages. However, solid foods may also be included in the food item selections in the refrigerated portion 22.

In accordance with one aspect of the present invention, each of the food groups utilized in the display system is represented by a distinct color. As shown in FIG. 1, each of shelves 24-27 of the room temperature portion 21 and shelves 33-36 of the refrigerated portion 22 are respectfully lined for the colors red for the protein food item shelves 24 and 33, yellow for the whole grain food shelves 25 and 34, purple for the fruit food shelves 26 and 35 and green for the vegetable food shelves 27 and 36. Preferably, the front edge or face of shelves 24-27 and 33-36 are enlarged in the vertical direction, as seen in FIG. 1, to accentuate the display of the respective colors selected for the shelves. However, the shelves 24-27 and 33-36 are not sufficiently enlarged in the vertical direction as to obscure or interfere with viewing and selection of the food items on the shelves.

Color coordination of the colors selected for the shelves in the display system 20 extends to the respective food items 28-31 and 37-40 in the display system 20. For example, if the color red is selected as the distinctive color for the protein food shelves 24 and 33, the packaging for the protein food items 28 and 37 is also selected as red, or vice versa. However, the packaging may be less than entirely red. For example, a shade of red may be selected, such as an orange-red, a pink-red, or the like. Distinctive color means that the colors selected for the other food items are different and that the selected colors contrast well against each other to provide at least some visual impact or attraction. In similar fashion, the packaging for the whole grain food items 29 and 38 may be selected as yellow to coordinate with the yellow color of the whole grain food shelves 25 and 34; the packaging for the fruit food items 30 and 39 may be selected as purple to coordinate with the purple color of the fruit food shelves 26 and 35; and the packaging for the vegetable food items 31 and 40 may be selected as green to coordinate with the green color of the vegetable food shelves 27 and 36. As for the color red selected for the protein food items 28, the colors yellow for the whole grain food items 29, the color purple for the fruit food items 30 and the color green for the vegetable food items 31 may be different shades of these respective colors. While the colors red, yellow, purple and green have been selected as representative of the four food groups that are offered in the display system 20 of FIG. 1, other colors may be substituted, if desired, such as the color blue for fruit food items 30 instead of the color purple. In general, the food items may include beverages, liquids, snacks and mini-meals.

The background color of the display system 20, including the color of the room temperature portion 21 and the color of the refrigerated portion 22, is preferably selected to be a neutral color as compared to the colors utilized on the shelves and on the packaging of the food items, such as white, naturally finished stainless steel or the like. A neutral color for the display system will assist in accentuating the colors selected for the food groups associated with the shelves 24-27 and 33-36.

A viewable portion of the packaging is generally the same color as that selected for the respective food groups. Typically, at least the upper portion of the packaging, or that portion of the packaging that is viewable above the edges of the shelves, for the food items 28-31 and 37-40 is the viewable portion which is generally of the same color as that selected for the respective food groups that will be utilized in the display system 20. This form of color coordination will provide an effective display of unique but separate colors in the display system 20 that will assist the shopper or customer in the selection of the desired food item. Thus, the color coordination may provide a uniform color effect when viewing the edge of the shelf and the packaging of the food items for any of the available food groups. If more brilliant shades of the different selected colors are utilized in the display system and on the packaging for the food items, the consumer will experience a strong visual impact upon viewing the display system and food items.

While the upper portions of the packaging for the food items is preferably of the same color as the shelves of the display system, it will be understood that such packaging frequently includes an identification of the food product, the trademark and/or logo of the supplier, a pictorial representation of the food product and a listing of the ingredients in the food item. Portions of these identifications, trademarks/logos and pictorial representations may be above, below, or both, of the upper portion of the packaging as seen when the food items are placed upon shelves. However, it is preferable to keep a significant amount of the upper portion of the packaging for the food items, as seen when the food items are on the shelves, of the same color as the shelf. For example, more than 50 percent of the viewable portion of the packaging of the food item may be preferable.

Those food items that are packaged in bottles or containers with tops, such as many of the food items 37-40 in the refrigerated portion 22 of display system 20 and some of the food items 28-31 in the room temperature portion 21, may have as their viewable portions color coordinated tops as well as coordinated coloring on, for example, at least the upper portion of the bottle for maximum color coordination effect. Of course, as before, portions or all of the cap and portions of the bottle may be reserved for an identification of the food product, trademarks/logos, and/or pictorial representations. With respect to bottle-type containers, colored labels may be used that cover a portion of the body of the bottle, but not entirely the whole bottle.

As can be seen in the display system of FIG. 1, the food items 28-31 and 37-40 are located adjacently to the same colors used on the respective shelves 24-27 and 33-36. In this display system, the colored edges on the shelves 24-27 and 33-36 also wrap around the sides of the shelves for maximum two-dimensional color effect. The food items from the respective food groups, combined with the adjacent color coordination of the shelves, are thus separated or segregated in the display system from the food items of the other available food groups to form distinctive color groups or clusters. Some open space in the vertical direction between the shelves, as shown in FIG. 1, will assist in accentuating the separation of the color grouping of the food items from the available food groups. Typical customers will thus quickly learn the colors associated with their favorite food items, which will make selection of the desired food items more convenient at the next purchasing event or opportunity.

Likewise, the colored edge of the shelves are not likely to be entirely of the selected colors, respectively, since it will be desirable to have an identification of the type of food on each shelf, such as protein, whole grain, fruit or vegetable, as previously described. However, it is preferable to have each shelf predominantly colored with the selected color for maximum color coordination effect.

Another embodiment of a display system, generally designated 50, is shown in FIG. 2. Display system 50 is considered to be the preferred embodiment of the present invention. Display system 50 is generally similar to display system 20 of FIG. 1, except the separate fruit and vegetable food groups on shelves 26-27 and 35-36 in FIG. 1 have been combined into a single shelf 56 in the room temperature portion and into a single shelf 65 in the refrigerated portion 52. In the example of FIG. 2, the combined fruit and vegetable shelves 56 and 65 are lined for the color green. These combined fruit and vegetable shelves may have food items 60 and 68 that consist of fruit, vegetables or combinations thereof. Thus, there is no separate shelf that is colored purple in display system 50 as for the fruit shelves 26 and 35 in display system 20 of FIG. 1.

The food groups or types of food items available in any of the display systems of the present invention may be combined, as desired, to increase or to decrease the number of food groups available in any particular display system. For example, the separate fruit and vegetable food groups in FIG. 1 are combined into a single fruit and vegetable food group in FIG. 2 such that three food group choices are available in display system 50 as compared to four food group choices in display system 20. As another example, an oils food group could be added, if desired.

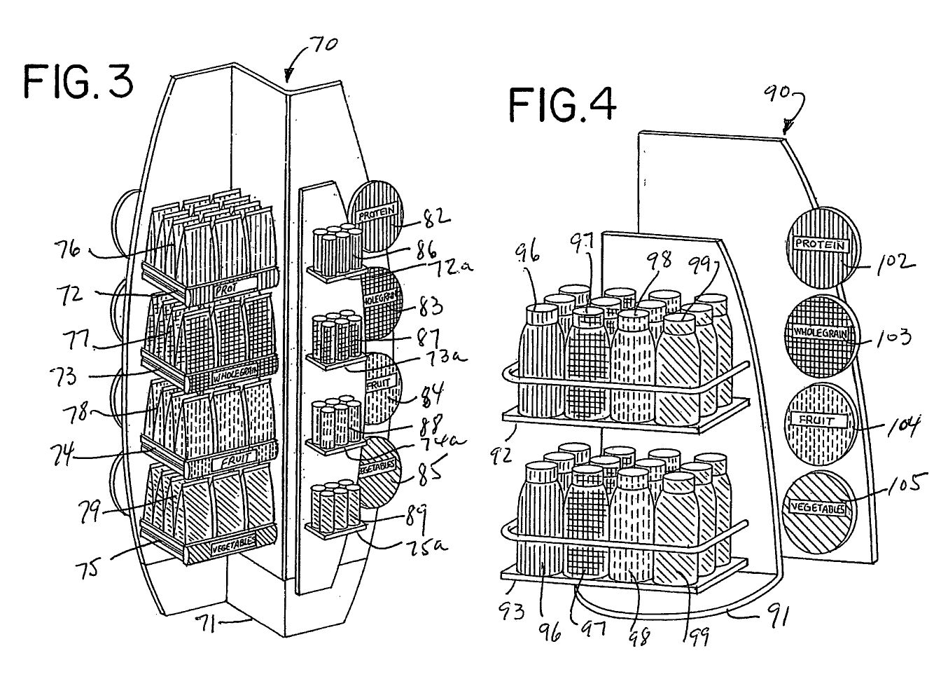

FIG. 3 illustrates a display system, generally designated 70, having a base 71 suitable for sitting on a counter or other raised surface. In a manner similar to display system 20 of FIG. 1, display system 70 of FIG. 3 offers four food group choices, namely protein on shelf 72, whole grains on shelf 73, fruit on shelf 74 and vegetables on shelf 75. The front edges of the shelves 72-75 are colored similarly to corresponding shelves in FIG. 1 and to the respective available food groups. In addition, a plurality of badges or medallions 82-85 also identifies the respective food groups and displays the respective colors for these food groups. Badges 82-85 are also disposed at about the same elevation as the corresponding shelves for the identified food groups. A plurality of auxiliary shelves 72a through 75a may also be disposed at about the same elevation as the corresponding shelves 72-75 for displaying additional or smaller packages of the food items for the respective food groups. Thus, each of the available food groups is displayed generally horizontally at about the same elevation, such as shelves 72 and 72a and badge 72 for the protein group.

Display system 70 of FIG. 3 is effectively a two sided display, but could be easily be configured to a single-sided display, a four-sided display, or the like. As previously explained above, the packaging for the food items 76-79 and 86-89 is preferably predominantly of the selected color for the associated food group with the exception of identifying product information, trademarks/logos, pictorial information and the like that is commonly used on the packaging for food items.

Another variation of a display system, generally designated 90, is shown in FIG. 4. Rather than utilizing separate color coordinated shelves for each available food group, display system 90 has a pair of shelves 92 and 93 with the food items 96-99 from the available food groups arranged in rows from the front of the display system toward the back. Thus, shelves 92-93 each accommodate four rows of the four available food groups, namely protein, whole grain, fruit and vegetables. This provides visually distinct colored rows of food items in a vertical direction since similarly colored packaging for food items in the same food group are also disposed above or below each other. In a manner similar to display system 70 in FIG. 3, display system 90 of FIG. 4 utilizes four prominently colored badges or medallions 102-105 to associate the color of the packaging of food items 96-99 with the same color of the respective badges to assist the purchaser in quickly identifying the color of the desired food group and to assist in the selection of the food item 96-99 from the desired food group.

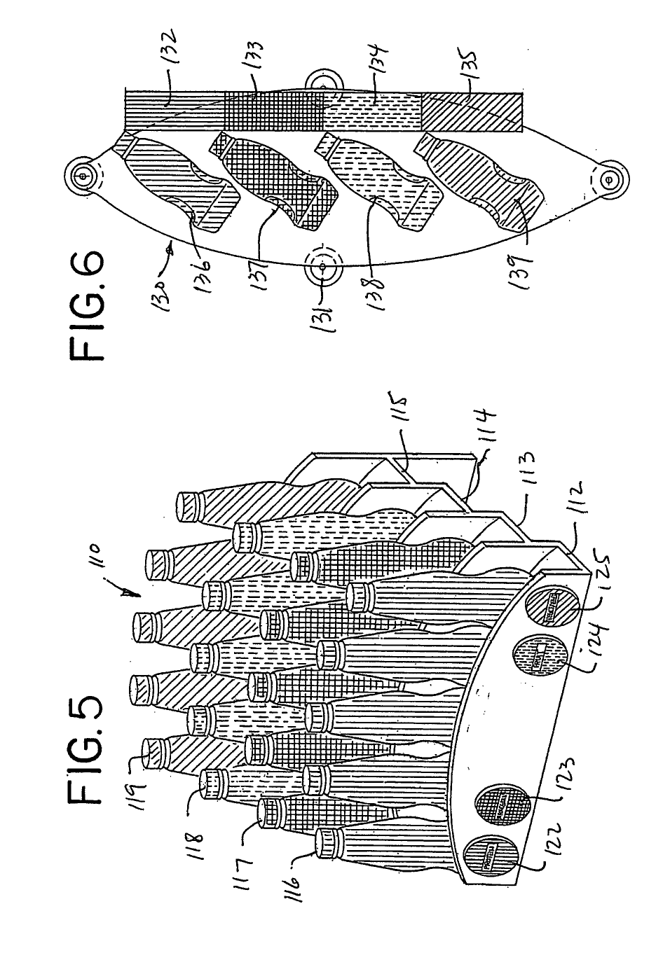

Another display system, generally designated 110, is illustrated in FIG. 5. Display system 110 is also suited for sitting on a counter, in or over a horizontally disposed cooler such as is commonly used for meat products in grocery stores. It has a plurality of steps 112-115, with each step suited for holding and displaying a row of food items from each of the available food groups. Steps 112-115 define spaced-apart rows or spaces. A plurality of prominent badges or medallions 122-125 is disposed on the front of the display system and the badges are each colored in accordance with the respective food group that the particular badge represents. Moreover, since each of the steps 112-115 is higher in elevation than the preceding step, the rows of food items 116-119 of the different available food groups are at successively higher elevations than the preceding row for optimum viewing of the available selections by the consumer. The selection of colors for the available food groups and the coloring of the packaging for the food items 116-119 are generally as previously described for the embodiments of the other display systems.

FIG. 6 illustrates yet another embodiment of a display system, generally designated 130. Display system 130 has a plurality of suction cups 131 for attachment of the display system to a vertical surface, such as a wall, the side of a refrigerated unit or the like. Of course, other means of attaching this display system to a vertically disposed surface may be employed, if so desired. The packaging for a plurality of food items 136-139 are lined for the colors red, yellow, purple and green, respectively. An adjacent color strip consists of a plurality of colored segments 132-135, similarly lined for the colors red, yellow, purple and green, respectively. While not shown, these colored segments 132-135 may also identify the respective food groups for the adjacently located and similarly colored food items; such as protein, whole grain, fruit and vegetables.

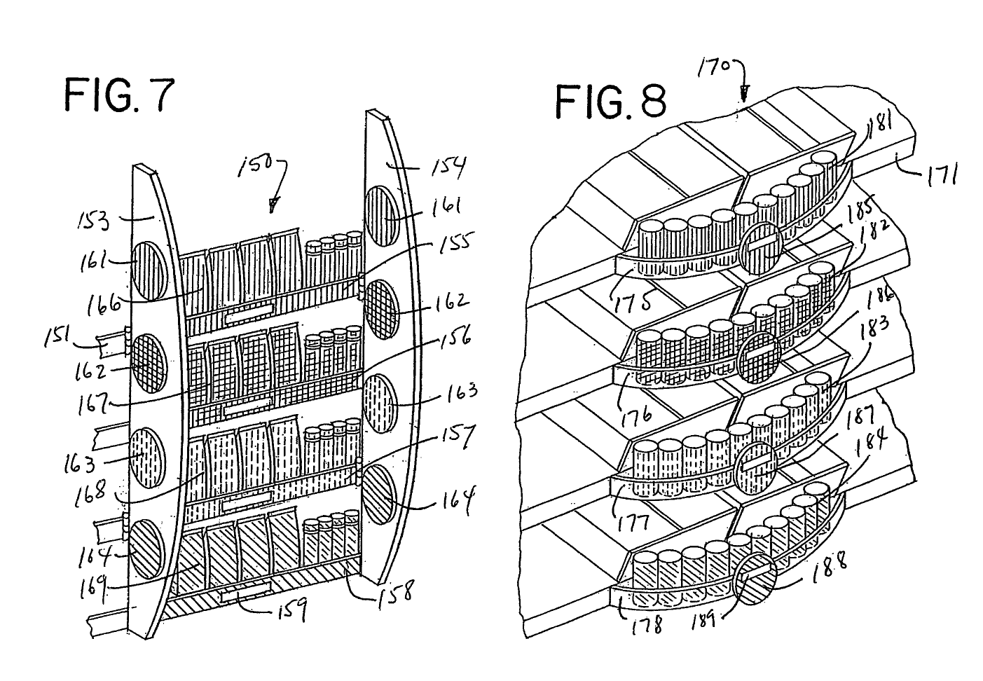

A further embodiment of a display system, generally designated 150 is shown in FIG. 7. Display system 170 is designed for installation on typical horizontally and spaced-apart grocery store shelving 151. Colored strips or bands 155-158 are placed over the front edges of the shelving 151, with each of the colored strips selected to be one of the colors associated with the available food groups, such as red for protein (strip 155), yellow for whole grain (strip 156), purple for fruit (strip 157) and green for vegetables (strip 158). Each of strips 155-158 may have an uncolored area, such as the rectangular area 159 in strip 158, for indicating the name of the food group on the respective shelf 151. For maximum visual color effect, the strips 155-158 may be of larger width than the edge of the shelf. As with many of the other display systems, it is desirable to stock the shelves 151 with food items 166-169 of the same color as strips 155-158 such that the food items of the selected food groups are grouped together in distinctive color groups.

Display system 150 may be further provided with one or more sideboards 153-154 that are vertically disposed along each side of the display system, and that extend forwardly from the front edges of shelves 151. Colored badges or medallions 161-164 are disposed on the sideboards 153-154 at spaced locations adjacently to the respectively colored strips 155-159 and the respectively colored packaging for food items 166-169 such that the badges, food items and strips of the same colors are grouped together.

Another embodiment of a display system, generally designated 170, for implementation on the existing shelving of a grocery store is shown in FIG. 8. Display system 170 consists of a plurality of curved or arcuate shelf extensions 175-178 that attach to the front edges of shelves 171 and extend or project forwardly therefrom. In the example of FIG. 8, the shelf extensions are disposed in vertical relationship, with one shelf extension disposed on the edge of each shelf 171. Of course, the shelf extensions could also be disposed horizontally with all of the shelf extensions 175-178 disposed on the edge of one of the shelves 171, such as at spaced intervals. While not so indicated in FIG. 8, the front edges of the shelf extensions 175-178 may be colored with the selected colors that represent the available food groups.

A plurality of food items 181-184 are grouped in the respective shelf extensions 175-178 with the same designated color. A plurality of color coordinating badges or medallions 185-188 are disposed on the front of respective shelf extensions 175-178 to assist in the color coordination of the differently colored food product groups and in the selection of the desired food items. Each of colored badges 185-188 may have a blank area, such as area 189 in badge 188, for a written indication of type of food product available in that particular shelf extension.

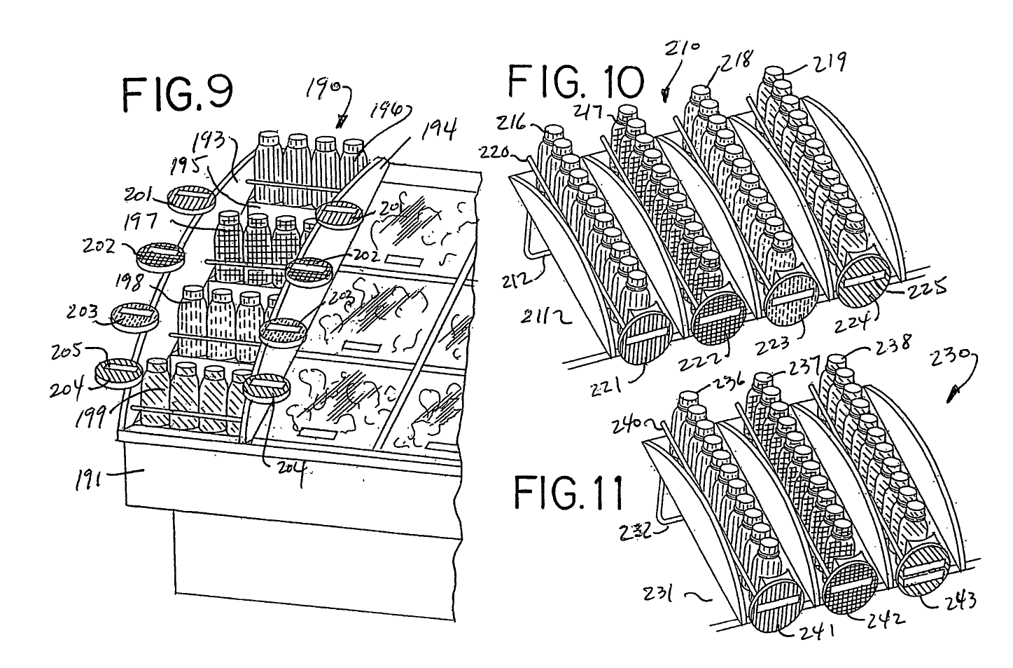

Yet another variation of a color coordinated display system, generally designated 190, is illustrated in FIG. 9. Display system 190 is especially suited for overlaying on a portion of a generally horizontal cooler 191, such as those commonly used in grocery stores for vegetables, meats and the like. A plurality of steps, such as step 195, are disposed from the front of display system 190 to the rear thereof to elevate each successive row or space for food items 196-199 above the previous row or space. A pair of sideboards 193-194 keeps the food items from falling laterally off of the display system and also provides a support for a plurality of colored badges or medallions 201-204. As with some of the previously described display systems, badges 201-204 are colored in accordance with the packaging of adjacently located food items to assist the shopper in the selection of the food items from the desired food groups.

Another display system, generally designated 210, is shown in FIG. 10. Display system 210 is suitable for sitting on a counter 211 or other generally horizontal surface. It is generally elevated, such as by a rear stand or foot 212, from the front to the rear with four rows of food items 216-219. Wire-like guides 220 may be employed on both sides of food items 216-219 to align the food items in generally straight rows within the display system. Because the display system 210 is elevated toward the rear, removal of a food item from the front of the display system will permit the remaining food items in the same row to slide forward. Such a gravity feed arrangement will keep the remaining food items toward the front of the display system 210. A plurality of badges or medallions 221-224 is disposed at the front of the rows of food items, with each badge color coordinated to the color of the packaging of the food items in each respective row. In the manner of certain previously described display systems, an uncolored area 225 may be provided on badges 221-224 for a written description of the food group available in each row.

A display system, generally designated 230, is illustrated in FIG. 11. Display system 230 of FIG. 11 is similar to display system 210 of FIG. 10, except that display system 230 has three rows and, therefore, three food group choices available instead of the four rows and the four food group choices available in display system 210. For example, the vegetable and fruit food groups may be combined, or one of the four food groups eliminated, to reduce the number of food group selections from four to three.

While particular embodiments of the invention have been shown and described, it will be obvious to those skilled in the art that changes and modifications may be made therein without departing from the invention in its broader aspects.

1. A display system comprising:
a plurality of food items, each of the plurality of food items enclosed in packaging;
each of said plurality of food items associated with one of a plurality of food groups;
a distinctive color selected to represent each of the plurality of food groups;
at least a viewable portion of said packaging of the plurality of food items each colored with the distinctive color that represents one of the plurality of food groups;
a display for displaying the plurality of food items, the display having provision for arranging the food items into separately colored groups representative of each of the plurality of food groups; and
said display having a plurality of indicia, each of said plurality of indicia colored in accordance with distinctive colors that represent each of the plurality of food groups, each of said plurality of indicia disposed in proximity to each of the respective food items from the respective food group of the same color.

2. The display system in accordance with claim 1 wherein said display has a plurality of shelves, each of said shelves including an edge, and said plurality of indicia comprise coloring on the edge on each shelf of one of the colors that is representative of one of the plurality of food groups.

3. The display system in accordance with claim 1 wherein said display has a plurality of spaces for separately arranging the food items associated with one of the plurality of food groups in each of the plurality of spaces.

4. The display system in accordance with claim 1 wherein said display has a plurality of rows for separately arranging the food items associated with one of the plurality of food groups in each of the plurality of rows.

5. The display system in accordance with claim 1 wherein said plurality of indicia comprises a plurality of badges, one of each of said plurality of badges colored with one of the colors representative of one of the plurality of food groups and each of said plurality of badges is located in proximity to the respectively colored food group.

6. The display system in accordance with claim 5 wherein each of said plurality of badges has a space for identifying the related food group.

7. The display system in accordance with claim 1 wherein said plurality of food groups is selected from the group consisting of protein, whole grain, fruit and vegetable.

8. The display system in accordance with claim 8 wherein at least one of said plurality of food groups consists of a combined food group such as vegetable and fruit.

9. The display system in accordance with claim 7 wherein the color red is associated with the protein food group, the color yellow is associated with the whole grain food group, the color purple is associated with the fruit food group and the color green is associated with the vegetable food group.

10. The display system in accordance with claim 1 wherein said display comprises a refrigerated portion and a room temperature portion.

11. The display system in accordance with claim 1 wherein each of said plurality of indicia includes an identification of the food group associated with the color selected for each respective food group.

12. A method of displaying a plurality of food items from a plurality of food groups in a display system, said method comprising the steps of:
selecting a distinctive color to represent each of the plurality of food groups,
coloring at least a viewable portion of packaging of the food items in accordance with the respective food group of the food items,
arranging the food items in the display system in accordance to the color of the packaging to form separately colored groups of food items,
providing indicia on the display system that are colored in accordance with the colors selected for each of the plurality of food groups, and
disposing each of said indicia on the display system in proximity to the separately colored groups of food items of the same color.

13. The method of displaying a plurality of food items in accordance with claim 12 wherein said display system includes a plurality of shelves, each of the shelves having an edge, said method comprising the additional steps of:
disposing each of the separately colored groups of food items on a separate shelf such that all of the food items on any shelf are of the same color; and
coloring the edge of each of the shelves in accordance with the same color as the food items disposed on that shelf.

14. The method of displaying a plurality of food items in accordance with claim 12, said method comprising the additional step of:
providing an indication on the edge of each shelf of the food group associated with the respective color on the edge.

15. The method of displaying a plurality of food items in accordance with claim 12 wherein said display system includes a plurality of spaces, said method comprising the additional step of:
arranging each of the separately colored groups of food items in one of the plurality of spaces such that all of the food items in any space are of the same color.

16. The method of displaying a plurality of food items in accordance with claim 12 wherein the step of providing indicia on the display system includes the steps of:
providing a plurality of badges, and
coloring each of said plurality of badges with one of the colors associated with each of the plurality of food groups.

17. The method of displaying a plurality of food items in accordance with claim 12 wherein said display system includes a plurality of shelves with each of the shelves having an edge and wherein the step of providing indicia on the display system includes the step of:
providing a colored edge on each of the shelves in accordance with the same color as the food items disposed on that shelf.

18. The method of displaying a plurality of food items in accordance with claim 12 wherein said display system includes a plurality of rows, said method comprising the additional step of:
arranging each of the separately colored groups of food items in one of the plurality of rows such that all of the food items in any row are of the same color.

19. The method of displaying a plurality of food items in accordance with claim 12, said method comprising the additional step of:
selecting the plurality of food groups from the group consisting of protein, whole grain, fruit and vegetable.

20. The method of displaying a plurality of food items in accordance with claim 19, said method comprising the additional step of:
selecting at least one of the food groups to be a combined food group such as fruit and vegetable.

21. The method of displaying a plurality of food items in accordance with claim 19, said method comprising the additional step of:
selecting the color red to be associated with the protein food group, the color yellow to be associated with the whole grain food group, the color purple to be associated with the fruit food group and the color green to be associated with the vegetable food group.

22. The method of displaying a plurality of food items in accordance with claim 12, said method comprising the additional step of:
providing an identification of the respective food group on each of said indicia that is associated with the selected color on each of said indicia.
